(19) United States
(12) Patent Application Publication
(10) Pub. No.: US 2013/0276596 A1
(43) Pub. Date: Oct. 24, 2013

(54) Star-Type Wrench

(71) Applicant: Liang-Hui Lin, Taichung City (TW)

(72) Inventor: Liang-Hui Lin, Taichung City (TW)

(21) Appl. No.: 13/450,554

(22) Filed: Apr. 19, 2012

(51) Int. Cl. B25B 23/00

(52) U.S. Cl. 81/460

(57) ABSTRACT

A star-type wrench includes a shank, a first operation portion mounted on a first end of the shank, and a second operation portion mounted on a second end of the shank. The shank is formed integrally to have a star-shaped outer diameter. Thus, the shank has a star-shaped outer diameter so that when the first operation portion or the second operation portion is broken, the first operation portion or the second operation portion can be removed from the shank, and the shank can function as an auxiliary operation portion and can be reused and operated successively.

### BACKGROUND OF THE INVENTION

1. Field of the Invention

The present invention relates to a wrench and, more particularly, to a star-type wrench.

2. Description of the Related Art

A conventional star-type wrench 1 in accordance with the prior art shown in FIG. 3 comprises a shank 11, a first operation portion 12 mounted on a first end of the shank 11, and a second operation portion 13 mounted on a second end of the shank 11. The shank 11 is made of a circular rod which has a substantially L-shaped profile. The first operation portion 12 is worked by cutting to have a star-shaped outer diameter. The second operation portion 13 has an end face provided with a spherical plug 131 and has a periphery provided with a plurality of slots 132. The second operation portion 13 is worked by cutting to form the spherical plug 131 and the slots 132. When in use, the first operation portion 12 is inserted into a star-shaped recess (not shown) of a workpiece (not shown), and the shank 11 is driven by a user to rotate the first operation portion 12 so that the first operation portion 12 is rotated to drive the workpiece. Thus, the star-type wrench 1 can be used to tighten or loosen the workpiece. However, the first operation portion 12 is worked by cutting to have a star-shaped outer diameter so that the first operation portion 12 has reduced strength and torque, and the connection of the first operation portion 12 and the shank 11 is easily broken due to a stress concentration, thereby causing the first operation portion 12 inoperative. In addition, the second operation portion 13 is worked by cutting to form the spherical plug 131 and the slots 132 so that the second operation portion 13 has reduced strength and torque, and the connection of the second operation portion 13 and the shank 11 is easily broken due to a stress concentration, thereby causing the second operation portion 13 inoperative. Further, the star-type wrench 1 will fail when the first operation portion 12 or the second operation portion 13 is broken, thereby decreasing the lifetime of the star-type wrench 1, and thereby greatly causing consumption of material and resource.

### BRIEF SUMMARY OF THE INVENTION

In accordance with the present invention, there is provided a star-type wrench, comprising a shank, a first operation portion mounted on a first end of the shank, and a second operation portion mounted on a second end of the shank. The shank has a substantially L-shaped profile. The shank is formed integrally to have a star-shaped outer diameter. The second operation portion has an end face provided with a spherical plug and has a periphery provided with a plurality of slots.

Preferably, the first operation portion is formed integrally with the shank.

Preferably, the first operation portion has the same star-shaped outer diameter as that of the shank.

Preferably, the star-shaped outer diameter of the shank extends through a whole length of the shank.

Preferably, the star-shaped outer diameter of the shank extends to the first operation portion and the second operation portion respectively.

The primary objective of the present invention is to provide a star-type wrench with an enhanced torque.

According to the primary advantage of the present invention, the shank has a star-shaped outer diameter so that the shank has an enhanced torque and has a better working efficiency.

According to another advantage of the present invention, the first operation portion is formed integrally with the shank so that the first operation portion has an enhanced strength.

According to a further advantage of the present invention, the shank has a star-shaped outer diameter so that when the first operation portion or the second operation portion is broken, the first operation portion or the second operation portion can be removed from the shank, and the shank can function as an auxiliary operation portion and can be reused and operated successively.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a star-type wrench in accordance with the preferred embodiment of the present invention.

FIG. 2 is a side view of the star-type wrench as shown in FIG. 1.

FIG. 3 is an exploded perspective view of a conventional star-type wrench in accordance with the prior art.

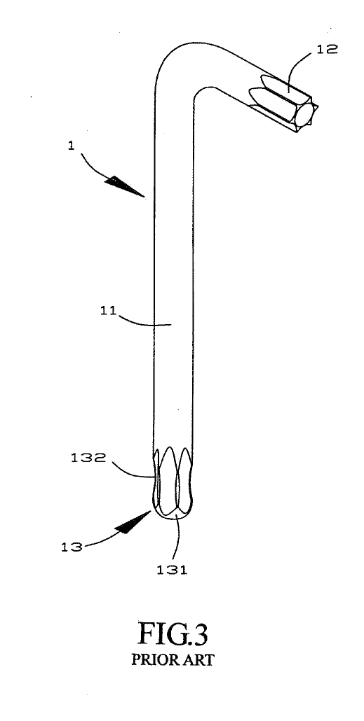

### DETAILED DESCRIPTION OF THE INVENTION

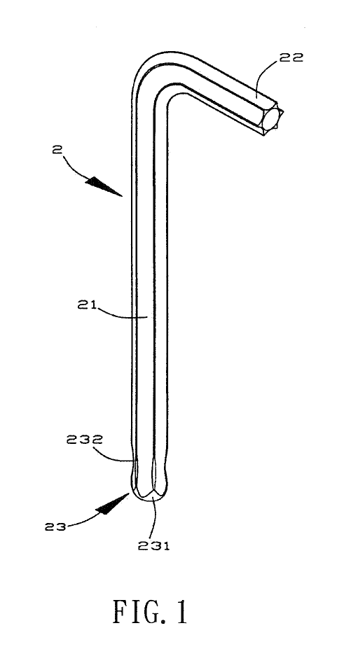

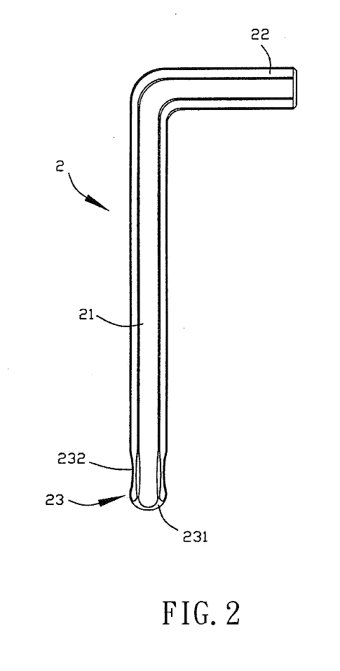

Referring to FIGS. 1 and 2, a star-type wrench 2 in accordance with the preferred embodiment of the present invention comprises a shank 21, a first operation portion 22 mounted on a first end of the shank 21, and a second operation portion 23 mounted on a second end of the shank 21. The shank 21 has a substantially L-shaped profile. The shank 21 is formed integrally to have a star-shaped outer diameter. The star-shaped outer diameter of the shank 21 extends through a whole length of the shank 21 and extends to the first operation portion 22 and the second operation portion 23 respectively. The first operation portion 22 is formed integrally with the shank 21. The first operation portion 22 has the same star-shaped outer diameter as that of the shank 21. The second operation portion 23 has an end face provided with a spherical plug 231 and has a periphery provided with a plurality of slots 232.

When in use, the first operation portion 22 is inserted into a star-shaped recess (not shown) of a workpiece (not shown), and the shank 21 is driven by a user to rotate the first operation portion 22 so that the first operation portion 22 is rotated to drive the workpiece. Thus, the star-type wrench 1 can be used to tighten or loosen the workpiece. In such a manner, the shank 21 has a star-shaped outer diameter so that the shank 21 has an enhanced torque to enhance the working efficiency of the star-type wrench 1. In addition, the first operation portion 22 is formed integrally with the shank 21 so that the strength of the connection of the first operation portion 22 and the shank 21 is not weakened by working, thereby enhancing the strength of the first operation portion 22. Further, the star-shaped outer diameter of the shank 21 extends to the first operation portion 22 and the second operation portion 23 respectively so that when the first operation portion 22 or the second operation portion 23 is broken, the first operation portion 22 or the second operation portion 23 can be removed from the shank 21, and the star-shaped outer diameter of the shank 21 can function as an auxiliary operation portion and can be reused and operated successively.

Accordingly, the shank 21 has a star-shaped outer diameter so that the shank 21 has an enhanced torque and has a better working efficiency. In addition, the first operation portion 22 is formed integrally with the shank 21 so that the first operation portion 22 has an enhanced strength. Further, the shank 21 has a star-shaped outer diameter so that when the first operation portion 22 or the second operation portion 23 is broken, the first operation portion 22 or the second operation portion 23 can be removed from the shank 21, and the shank 21 can function as an auxiliary operation portion and can be reused and operated successively.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A star-type wrench, comprising:
a shank;
a first operation portion mounted on a first end of the shank; and
a second operation portion mounted on a second end of the shank;
wherein the shank has a substantially L-shaped profile;
the shank is formed integrally to have a star-shaped outer diameter;
the second operation portion has an end face provided with a spherical plug and has a periphery provided with a plurality of slots.

2. The star-type wrench of claim 1, wherein the first operation portion is formed integrally with the shank.

3. The star-type wrench of claim 1, wherein the first operation portion has the same star-shaped outer diameter as that of the shank.

4. The star-type wrench of claim 1, wherein the star-shaped outer diameter of the shank extends through a whole length of the shank.

5. The star-type wrench of claim 1, wherein the star-shaped outer diameter of the shank extends to the first operation portion and the second operation portion respectively.
